(19) United States
(12) Patent Application Publication
(10) Pub. No.: US 2021/0163001 A1
(43) Pub. Date: Jun. 3, 2021

(54) SYSTEM AND METHOD FOR CORRECTING CURVATURE INFORMATION USING SURROUNDING VEHICLE AND METHOD THEREOF

(71) Applicant: HYUNDAI MOBIS Co., Ltd., Seoul (KR)

(72) Inventor: Kwang Il CHOI, Yongin-si (KR)

(21) Appl. No.: 17/095,680

(22) Filed: Nov. 11, 2020

(30) Foreign Application Priority Data
Nov. 29, 2019 (KR) 10-2019-0156566

(51) Int. Cl. B60W 30/16; B60W 30/12; G06T 7/90

(52) U.S. Cl. CPC B60W 30/16; B60W 30/12; G06T 7/90; B60W 2540/18; G06T 2207/30252; B60W 2420/42; B60W 2420/52; G06T 2207/10028; B60W 2552/30

(57) ABSTRACT

A system and a method for correcting curvature information using a surrounding vehicle, including a forward sensor that has a view range of a certain angle range to capture an image of a lane or a preceding vehicle in front of a host vehicle and provides a depth image of the preceding vehicle, a curvature calculating device that obtains location information of preceding vehicles, calculate curvatures of the preceding vehicles based on the location information of the preceding vehicles, and calculate an average value of the calculated curvatures of the preceding vehicles to estimate a final curvature, when reliability of a lane detection curvature signal does not meet a certain value as the view range decreases to a certain range or less, and a driving controller that corrects curvature information used for a driving convenience system by applying the final curvature to the host vehicle.

### CROSS-REFERENCE TO RELATED APPLICATION

This application claims the benefit of priority to Korean Patent Application No. 10-2019-0156566, filed in the Korean Intellectual Property Office on Nov. 29, 2019, the entire contents of which are incorporated herein by reference.

### BACKGROUND

### Field

Exemplary embodiments relate to systems and methods for correcting curvature information using a surrounding vehicle, and more particularly, relate to systems and methods for correcting curvature information using a surrounding vehicle to prevent an advanced driving assistance system (ADAS) driving convenience system from performing incorrect control, and to enhance utilization of the ADAS driving convenience system by correcting curvature information using location information of preceding vehicles when a host vehicle rotates on an intersection part.

### Discussion of the Background

An ADAS is a safety device of the vehicle, which detects a collision risk in the same concept as being recognized by a driver through visual, audible, and tactile elements using advanced sensors to warn he driver about an accident risk and decelerates to avoid a forward/side collision or actively performs emergency braking.

The ADAS may be classified into various types according to its function.

A forward collision warning system (FCW) is a system which detects a vehicle traveling in the direction in front of the line and provides a driver with visual, audible, and tactile warnings for the purpose of avoiding a collision with a forward vehicle.

An advanced emergency braking system (AEBS) is a system which detects a probability of a collision with a vehicle in front of the line to warn a driver about the probability and automatically brakes the vehicle for the purpose of mitigating and avoiding collision, when there is either no reaction of the driver or when it is determined that the collision is unavoidable.

An adaptive cruise control (ACC) is a system which autonomously drives the vehicle at a speed set by the driver, which is a system that controls the vehicle to follow a preceding vehicle without interrupting traffic flow and travel, when the preceding vehicle traveling below the speed set by the driver during autonomous driving appears, and a system which provides a function capable of automatically stopping the vehicle when meeting a preceding vehicle stopping on an intersection while driving and automatically starting the vehicle when the preceding vehicle starts.

In addition, the ADAS may be a lane departure warning system (LDWS), a lane keeping assist system (LKAS), a blind spot detection (BSD), a rear-end collision warning system (RCW), a smart parking assist system (SPAS), or the like.

However, when the vehicle turns at an intersection, there is a phenomenon in that curvature is excessively generated as a view range of the lane becomes narrow. When the curvature is excessively generated, there is an increase in probability that incorrect control will occur in an ADAS driving convenience system.

The above information disclosed in this Background section is only for enhancement of understanding of the background of the invention and, therefore, it may contain information that does not constitute prior art.

### SUMMARY

Exemplary embodiments of the present disclosure provide a system and method for correcting curvature information using a surrounding vehicle to calculate curvature information based on location information of a plurality of preceding vehicles, when a curvature signal by lane detection is not reliable due to a phenomenon where curvature is excessively generated as a view range of the lane captured by the camera becomes narrow when the vehicle mounting an ADAS driving convenience system rotates at an intersection; derive an average value of the plurality of calculated curvature information to estimate an average curvature of the preceding vehicles; and correct curvature information using the estimated curvature information of the preceding vehicles in an area where the view range of the lane captured by the camera becomes narrow, thus preventing the ADA driving convenience system from performing incorrect control and increasing utilization of the ADAS driving convenience system.

The technical problems to be solved by the inventive concept are not limited to the aforementioned problems, and any other technical problems not mentioned herein will be clearly understood from the following description by those skilled in the art to which the present disclosure pertains.

Additional features of the invention will be set forth in the description which follows, and in part will be apparent from the description, or may be learned by practice of the invention.

An exemplary embodiment of the present disclosure provides a system for correcting curvature information using a surrounding vehicle, including a forward sensor having a view range of a certain angle range to capture an image of a lane or a preceding vehicle in front of a host vehicle and to provide a depth image of the preceding vehicle; a curvature calculating device configured to obtain location information of preceding vehicles when reliability of a lane detection curvature signal does not meet a certain value as the view range decreases to a certain range or less; configured to calculate curvatures of the preceding vehicles based on the location information of the preceding vehicles; and configured to calculate an average value of the calculated curvatures of the preceding vehicles to estimate a final curvature. A driving controller is configured to correct curvature information used for a driving convenience system by applying the final curvature to the host vehicle.

The forward sensor may include a camera that captures an image of the lane or the preceding vehicle in front of the host vehicle to provide a YUV image (an encoded color image taking human perception into account) and a light detection and ranging (LIDAR) sensor that provides the depth image of the preceding vehicle.

The curvature calculating device may include a lane detector that calculates a first curvature based on a curved lane captured by the forward sensor; an object recognizer that calculates a second curvature based on a trajectory of one preceding vehicle, the trajectory being captured by the forward sensor; and a curvature calculator that estimates an average curvature of the curved lane using the first curvature and the second curvature.

The curvature calculating device may include a lane detector that calculates a first curvature based on a curved lane captured by the forward sensor; an object recognizer that calculates a plurality of second curvatures based on trajectories of a plurality of preceding vehicles, the trajectories being captured by the forward sensor and calculates relative location information of the preceding vehicles on the basis of a location of the host vehicle; and a curvature calculator that calculates third curvatures from the center point of a circle, the center point being away from the location of the host vehicle by a radius R, and calculates an average value of the calculated third curvatures of the preceding vehicles to estimate the final curvature.

The curvature calculator may calculate the third curvatures from the center point of the circle, the center point being away from the location of the host vehicle by the radius R, to the plurality of preceding vehicles using the following equation

$$\frac{1}{R} = \frac{2 y}{{x}^{2} + {y}^{2}}$$

(where R denotes the coordinate value of the center point of the circle, the center point being away from the location of the host vehicle by the radius R, X denotes the X-axis coordinate value of the preceding vehicle, and Y denotes the Y-axis coordinate value of the preceding vehicle).

The curvature calculator may calculate the average value of the third curvatures of the preceding vehicles using the following equation

$$\frac{1}{n} {\sum }_{i = 1}^{n} \frac{1}{{R}_{n}}$$

(where n denotes the number of the preceding vehicles).

The driving controller may deliver curvature information corrected according to the final curvature to a sensor rotating device for rotating the forward sensor or to a steering system for changing a steering angle of the host vehicle.

Another exemplary embodiment of the present disclosure provides a method for correcting curvature information using a surrounding vehicle may include obtaining, by a curvature calculating device, location information of preceding vehicles when reliability of a lane detection curvature signal does not meet a certain value as a view range of a camera decreases to a certain range or less in a forward sensor including the camera that captures an image of a lane or a preceding vehicle in front of a host vehicle to provide a YUV image (an encoded color image taking human perception into account) and a light detection and ranging (LIDAR) sensor that provides a depth image of the preceding vehicle; calculating, by the curvature calculating device, curvatures of preceding vehicles based on location information of the preceding vehicles; calculating, by the curvature calculating device, an average value of the calculated curvatures of the preceding vehicles to estimate a final curvature; and correcting, by a driving controller, curvature information used for a driving convenience system by applying the final curvature to the host vehicle.

The method may further include calculating, by a lane detector, a first curvature based on a curved lane captured by the forward sensor; calculating, by an object recognizer, a second curvature based on a trajectory of one preceding vehicle, the trajectory being captured by the forward sensor; and estimating, by a curvature calculator, an average curvature of the curved lane using the first curvature and the second curvature.

The method may further include calculating, by a lane detector, a first curvature based on a curved lane captured by the forward sensor; calculating, by an object recognizer, a plurality of second curvatures based on trajectories of a plurality of preceding vehicles, the trajectories being captured by the forward sensor and calculating, by the object recognizer, relative location information of the preceding vehicles on the basis of a location of the host vehicle; and calculating, by a curvature calculator, third curvatures, each of which has a straight line from the center point of a circle, the center point being away from the location of the host vehicle by a radius R, to the plurality of preceding vehicles as a radius and calculating, by the curvature calculator, an average value of the calculated third curvatures of the preceding vehicles to estimate the final curvature.

The method may further include calculating the third curvatures, each of which has the straight line from the center point of the circle, the center point being away from the location of the host vehicle by the radius R, to the plurality of preceding vehicles, as the radius using the following equation

$$\frac{1}{R} = \frac{2 y}{{x}^{2} + {y}^{2}}$$

(where R denotes the coordinate value of the center point of the circle, the center point being away from the location of the host vehicle by the radius R, X denotes the X-axis coordinate value of the preceding vehicle, and Y denotes the Y-axis coordinate value of the preceding vehicle).

The method may further include calculating the average value of the third curvatures of the preceding vehicles using the following equation

$$\frac{1}{n} {\sum }_{i = 1}^{n} \frac{1}{{R}_{n}}$$

(where n denotes the number of the preceding vehicles).

The method may further include delivering, by a driving controller, curvature information corrected according to the final curvature to a sensor rotating device for rotating the forward sensor or a steering system for changing a steering angle of the host vehicle.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a block diagram illustrating a system for correcting curvature information using a surrounding vehicle according to an embodiment of the present disclosure.

FIG. 2 is a drawing illustrating curvature information correction performed by a system for correcting curvature information using a surrounding vehicle according to an embodiment of the present disclosure.

FIG. 3 is a flowchart illustrating a method for correcting curvature information using a surrounding vehicle according to an embodiment of the present disclosure.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. Like reference numerals in the drawings denote like elements.

Unless defined otherwise, it is to be understood that all the terms (including technical and scientific terms) used in the specification has the same meaning as those that are understood by those who skilled in the art. Further, the terms defined by the dictionary generally used should not be ideally or excessively formally defined unless clearly defined specifically. It will be understood that for purposes of this disclosure, “at least one of X, Y, and Z” can be construed as X only, Y only, Z only, or any combination of two or more items X, Y, and Z (e.g., XYZ, XYY, YZ, ZZ). Unless particularly described to the contrary, the term “comprise”, “configure”, “have”, or the like, which are described herein, will be understood to imply the inclusion of the stated components, and therefore should be construed as including other components, and not the exclusion of any other elements.

Hereinafter, some embodiments of the present disclosure will be described in detail with reference to the exemplary drawings. In adding the reference numerals to the components of each drawing, it should be noted that the identical or equivalent component is designated by the identical numeral even when they are displayed on other drawings. Further, in describing the embodiment of the present disclosure, a detailed description of well-known features or functions will be ruled out in order not to unnecessarily obscure the gist of the present disclosure.

In describing the components of the embodiment according to the present disclosure, terms such as first, second, “A”, “B”, (a), (b), and the like may be used. These terms are merely intended to distinguish one component from another component, and the terms do not limit the nature, sequence or order of the constituent components. Unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

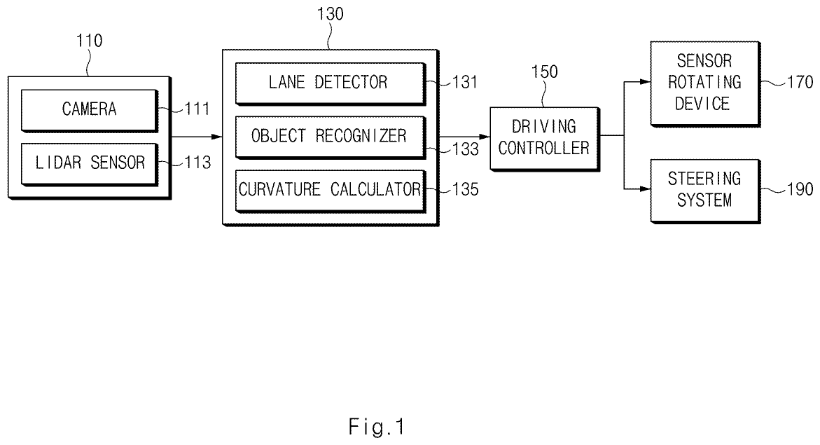

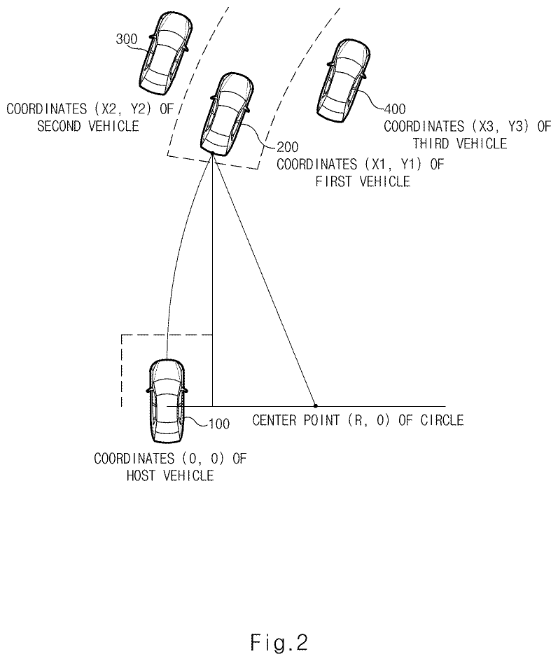

Hereinafter, embodiments of the present disclosure will be described in detail with reference to FIGS. 1 and 2.

FIG. 1 is a block diagram illustrating a system for correcting curvature information using a surrounding vehicle according to an embodiment of the present disclosure. FIG. 2 is a drawing illustrating curvature information correction performed by a system for correcting curvature information using a surrounding vehicle according to an embodiment of the present disclosure.

Referring to FIGS. 1 and 2, the system for correcting the curvature information using the surrounding vehicle according to an embodiment of the present disclosure may be configured to include a forward sensor 110, a curvature calculating device 130, and a driving controller 150.

The forward sensor 110 may have a view range of a certain angle range to sense the front of a host vehicle 100, which may include a camera 111 and a light detection and ranging (LIDAR) sensor 113.

The camera 111 may generate a YUV image (an encoded color image taking human perception into account) in front of the host vehicle 100 and may provide the curvature calculating device 130 with the generated YUV image. The YUV image provided from the camera 111 may be used to detect a lane using image processing or recognize forward objects including a preceding vehicle.

The LIDAR sensor 113 may generate a depth image in front of the host vehicle 100 and may provide the curvature calculating device 130 with the generated depth image. The depth image provided from the LIDAR sensor 113 may be used to recognize and track forward objects including a preceding object.

The curvature calculating device 130 may calculate a curvature of a curved lane on an intersection or the like using information obtained from the forward sensor 110 and may deliver the calculated curvature to the driving controller 150, which may be configured to include a lane detector 131, an object recognizer 133, and a curvature calculator 135.

The lane detector 131 may receive the YUV image from the camera 111 and may detect a lane. The lane detection may be performed through image processing of the YUV image. For example, the lane detector 131 may generate a contour image from the YUV image and may detect a lane from the YUV image with regard to luminance characteristics of the lane (e.g., a lane displayed in a bright color) or a geometric characteristic (e.g., a location, a thickness, or the like).

Thus, the lane detector 131 may calculate a first curvature using a trajectory of the detected lane and may provide the curvature calculator 135 with the first curvature to be used to estimate a curvature of a curved lane.

The object recognizer 133 may receive the YUV image from the camera 111 and may receive the depth image from the LIDAR sensor 113. The object recognizer 133 may recognize a forward object (particularly, one preceding vehicle which is traveling in front of the host vehicle 100) using the YUV image and the depth image and may track the forward object to calculate a movement trajectory of the preceding vehicle.

Thus, the object recognizer 133 may calculate a second curvature of the curved lane using the calculated movement trajectory of the one preceding vehicle and may provide the curvature calculator 135 with the second curvature to be used to estimate a curvature of the curved lane.

The curvature calculator 135 may estimate a final curvature of the host vehicle 100 which performs curved driving on an intersection or the like, using the first curvature and the second curvature respectively received from the lane detector 131 and the object recognizer 133.

For example, the curvature calculator 135 may estimate the final curvature based on correction or the like by an average value of the first curvature and the second curvature, a weight, or the like. Alternatively, the curvature calculator 135 may estimate one of the first curvature or the second curvature as the final curvature depending on an environment where the host vehicle 100 is traveling.

For example, when the host vehicle 100 is traveling in a night environment, the curvature calculator 135 may estimate the second curvature as the final curvature. When there is no preceding vehicle in front of the host vehicle 100, the curvature calculator 135 may estimate the first curvature as the final curvature.

Meanwhile, when the host vehicle 100 is traveling on a curved section in an intersection or the like, a view range of the forward sensor 110 may decrease to a certain range or less and, due to this, the reliability of a curvature signal by lane detection may fail to meet a certain value.

In this case, when there are a plurality of preceding vehicles, the curvature calculating device 130 may obtain location information of the preceding vehicles, may calculate curvatures of the preceding vehicles based on the location information of the preceding vehicles, and may calculate an average value of the calculated curvatures of the preceding vehicles to estimate the final curvature.

In other words, in a state where reliability of the first curvature calculated by the lane detector 131 does not meet the certain value, when a first preceding vehicle 200, a second preceding vehicle 300 and a third preceding vehicle 400 are recognized by the object recognizer 133, the curvature calculating device 130 may calculate second curvatures based on trajectories of the first preceding vehicle 200, the second preceding vehicle 300, and the third preceding vehicle 400, and may calculate relative location information of the first preceding vehicle 200, relative location information of the second preceding vehicle 300, and relative location information of the third preceding vehicle 400 on the basis of a location of the host vehicle 100.

For example, location coordinates of the host vehicle 100 may be calculated as coordinates (0, 0), location coordinates of the first preceding vehicle 200 may be calculated as coordinates (x1, y1), location coordinates of the second preceding vehicle 300 may be calculated as coordinates (x2, y2), and location coordinates of the third preceding vehicle 400 may be calculated as coordinates (x3, y3).

Subsequently, the curvature calculator 135 may calculate third curvatures from a center point (location coordinates (R, 0)) of the circle, which is away from the location coordinates (0, 0) of the host vehicle 100 by a radius R, to the first preceding vehicle 200, the second preceding vehicle 300, and the third preceding vehicle 400 and may calculate an average value of the calculated third curvatures of the first preceding vehicle 200, the second preceding vehicle 300, and the third preceding vehicle 400 to estimate the final curvature.

First of all, the third curvature from the center point (R, 0) of the circle, which is away from the location coordinates (0, 0) of the host vehicle 100 to an inner side of the X-axis direction by the radius R, to the location coordinates (x1, y1) of the first preceding vehicle 200 may be calculated using Equation 1 below.

$$\begin{matrix}{x}_{1}^{2} + {( {y}_{1} - R )}^{2} = {R}^{2} & [ Equation 1 ] \\ {x}_{1}^{2} + {y}_{1}^{2} - 2 {y}_{1} R + {R}^{2} = {R}^{2} \\ {x}_{1}^{2} + {y}_{1}^{2} = 2 {y}_{1} R \\ \frac{1}{{R}_{1}} = \frac{2 {y}_{1}}{{x}_{1}^{2} + {y}_{1}^{2}} & \end{matrix}$$

Herein, R denotes [symbol] is away from the location of the host vehicle by the radius R, x1 denotes an X-axis coordinate value of the first preceding vehicle, and y1 denotes a Y-axis coordinate value of the first preceding vehicle.

In such a manner, the third curvature from the center point (R, 0) of the circle to the location coordinates (x2, y2) of the second preceding vehicle 300 may be calculated using Equation 2 below, and the third curvature from the center point (R, 0) of the circle to the location coordinates (x3, y3) of the third preceding vehicle 400 may be calculated using Equation 3 below.

$$\begin{matrix}\frac{1}{{R}_{2}} = \frac{2 {y}_{2}}{{x}_{2}^{2} + {y}_{2}^{2}} & [ Equation 2 ] \\ \frac{1}{{R}_{3}} = \frac{2 {y}_{3}}{{x}_{3}^{2} + {y}_{3}^{2}} & [ Equation 3 ]\end{matrix}$$

Herein, x2 denotes the X-axis coordinate value of the second preceding vehicle, y2 denotes the Y-axis coordinate value of the second preceding vehicle, x3 denotes the X-axis coordinate value of the third preceding vehicle, and y3 denotes the Y-axis coordinate value of the third preceding vehicle.

Subsequently, the curvature calculating device 130 may calculate an average value of the calculated third curvatures of the first preceding vehicle 200, the second preceding vehicle 300, and the third preceding vehicle 400 using Equation 4 below to estimate the final curvature.

$$\frac{1}{n} {\sum }_{i = 1}^{n} \frac{1}{{R}_{n}} \qquad [ Equation 4 ]$$

Herein, n denotes [symbol] preceding vehicles.

The final curvature estimated by the curvature calculating device 130 may be delivered to the driving controller 150. The driving controller 150 may reflect the final curvature in an ADAS driving convenience system, such as a sensor rotating device 170 for rotating the forward sensor 110 or a steering system 190 for changing a steering angle of the host vehicle 100 to correct an error of curvature information applied to the ADAS driving convenience system, thus reducing incorrect control when controlling running of the ADAS driving convenience system.

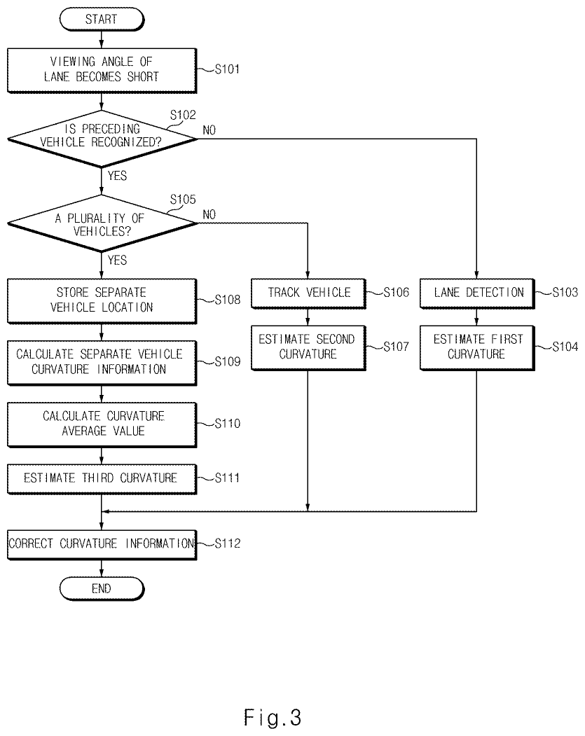

Hereinafter, a method for correcting curvature information using a surrounding vehicle according to another embodiment of the present disclosure will be described in detail with reference to FIG. 3. FIG. 3 is a flowchart illustrating a method for correcting curvature information using a surrounding vehicle according to an embodiment of the present disclosure.

Hereinafter, it is assumed that a system for correcting curvature information using a surrounding vehicle in FIG. 1 performs a process of FIG. 3.

First of all, in a forward sensor 110 including a camera 111 which captures an image of a lane or a preceding vehicle in front of a host vehicle 100 and provides a YUV image and a LIDAR sensor 113 which provides a depth image of the preceding vehicle, as a view range of the camera 111 decreases to a certain range or less in a curved range such as an intersection in S101, reliability of a lane detection curvature signal may fail to meet a certain value.

When a preceding vehicle is not recognized in S102, in S103 and S104, a lane detector 131 may calculate a first curvature based on a curved lane captured by the forward sensor 110 and may provide a curvature calculator 135 with the first curvature to be used to estimate a curvature of the curved lane.

When the preceding vehicle is recognized in S102 and when the recognized preceding vehicle is one vehicle in S105, in S106, an object recognizer 133 may calculate a second curvature of the is curved lane using the calculated movement trajectory of the one preceding vehicle. In S107, the object recognizer 133 may provide the curvature calculator 135 with the second curvature to be used to estimate a curvature of the curved lane.

When the recognized vehicle is plural in number in S105, in S108, a curvature calculating device 130 may obtain location information of the preceding vehicles by means of the object recognizer 133. In S109, the curvature calculating device 130 may calculate curvatures of the preceding vehicles by means of the curvature calculator 135 based on the location information of the preceding vehicles. In S110, the curvature calculating device 130 may calculate an average value of the calculated curvatures of the preceding vehicles. In S111, the curvature calculating device 130 may estimate a final curvature.

In S112, a driving controller 150 may apply the final curvature to the host vehicle 100 to correct curvature information used for an ADAS driving convenience system.

According to the above-mentioned system and method for correcting the curvature information using the surrounding vehicle, the system may calculate curvature information based on location information of the plurality of preceding vehicles, when a curvature signal by lane detection is not reliable due to a phenomenon where curvature is excessively generated as a view range of the lane captured by the camera becomes narrow when a vehicle mounting the ADAS driving convenience system rotates on an intersection part, may derive an average value of the plurality of calculated curvature information to estimate an average curvature of the preceding vehicles, and may correct curvature information using the estimated curvature information of the preceding vehicles in an area where the view range of the lane captured by the camera becomes narrow, thus preventing the ADAS driving convenience system from performing incorrect control and increasing utilization of the ADAS driving convenience system.

Meanwhile, the method for correcting the curvature information using the surrounding vehicle according to S101 to S112 according to an embodiment of the present disclosure may be programmed and stored in a storage medium to be readable by a computer.

The present technology may calculate curvature information based on location information of a plurality of preceding vehicles, when a curvature signal by lane detection is not reliable due to a phenomenon where curvature is excessively generated as a view range of the lane captured by the camera becomes narrow when the vehicle mounting the ADAS driving convenience system rotates on an intersection part, may derive an average value of the plurality of calculated curvature information to estimate an average curvature of the preceding vehicles, and may correct curvature information using the estimated curvature information of the preceding vehicles in an area where the view range of the lane captured by the camera becomes narrow, thus preventing the ADA driving convenience system from performing incorrect control and increasing utilization of the ADAS driving convenience system.

In addition, various effects ascertained directly or indirectly through the present disclosure may be provided.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

Therefore, the exemplary embodiments of the present disclosure are provided to explain the spirit and scope of the present disclosure, but not to limit them, so that the spirit and scope of the present disclosure is not limited by the embodiments. The scope of the present disclosure should be construed on the basis of the accompanying claims, and all the technical ideas within the scope equivalent to the claims should be included in the scope of the present disclosure.

What is claimed is:

1. A system for correcting curvature information using a surrounding vehicle, the system comprising:
a forward sensor configured to have a view range of a certain angle range to capture an image of a lane or a preceding vehicle in front of a host vehicle and provide a depth image of the preceding vehicle;
a curvature calculating device configured to:
obtain location information of preceding vehicles when reliability of a lane detection curvature signal does not meet a certain value as the view range decreases to a certain range or less;
calculate curvatures of the preceding vehicles based on the location information of the preceding vehicles; and
calculate an average value of the calculated curvatures of the preceding vehicles to estimate a final curvature; and
a driving controller configured to correct curvature information used for a driving convenience system by applying the final curvature to the host vehicle.

2. The system of claim 1, wherein the forward sensor includes:
a camera configured to capture an image of the lane or the preceding vehicle in front of the host vehicle to provide a YUV image (an encoded color image taking human perception into account); and
a light detection and ranging (LIDAR) sensor configured to provide the depth image of the preceding vehicle.

3. The system of claim 1, wherein the curvature calculating device includes:
a lane detector configured to calculate a first curvature based on a curved lane captured by the forward sensor;
an object recognizer configured to calculate a second curvature based on a trajectory of one preceding vehicle, the trajectory being captured by the forward sensor; and
a curvature calculator configured to estimate an average curvature of the curved lane using the first curvature and the second curvature.

4. The system of claim 1, wherein the curvature calculating device includes:
a lane detector configured to calculate a first curvature based on a curved lane captured by the forward sensor;
an object recognizer configured to calculate a plurality of second curvatures based on trajectories of a plurality of preceding vehicles, the trajectories being captured by the forward sensor, and calculate relative location information of the preceding vehicles on the basis of a location of the host vehicle; and
a curvature calculator configured to calculate third curvatures from the center point of a circle, the center point being away from the location of the host vehicle by a radius R, and calculate an average value of the calculated third curvatures of the preceding vehicles to estimate the final curvature.

5. The system of claim 4, wherein the curvature calculator calculates the third curvatures from the center point of the circle, the center point being away from the location of the host vehicle by the radius R, to the plurality of preceding vehicles using the following equation
$$\frac{1}{R} = \frac{2 y}{{x}^{2} + {y}^{2}}$$
where R denotes the coordinate value of the center point of the circle, the center point being away from the location of the host vehicle by the radius R, X denotes the X-axis coordinate value of the preceding vehicle, and Y denotes the Y-axis coordinate value of the preceding vehicle).

6. The system of claim 4, wherein the curvature calculator calculates the average value of the third curvatures of the preceding vehicles using the following equation
$$\frac{1}{n} {\sum }_{i = 1}^{n} \frac{1}{{R}_{n}}$$
(where n denotes the number of the preceding vehicles).

7. The system of claim 1, wherein the driving controller delivers curvature information corrected according to the final curvature to a sensor rotating device for rotating the forward sensor or to a steering system for changing a steering angle of the host vehicle.

8. A method for correcting curvature information using a surrounding vehicle, the method comprising:
obtaining, by a curvature calculating device, location information of preceding vehicles when reliability of a lane detection curvature signal does not meet a certain value as a view range of a camera decreases to a certain range or less in a forward sensor including the camera configured to capture an image of a lane or a preceding vehicle in front of a host vehicle to provide a YUV image (an encoded color image taking human perception into account) and a light detection and ranging (LIDAR) sensor configured to provide a depth image of the preceding vehicle;
calculating, by the curvature calculating device, curvatures of preceding vehicles based on location information of the preceding vehicles;
calculating, by the curvature calculating device, an average value of the calculated curvatures of the preceding vehicles to estimate a final curvature; and
correcting, by a driving controller, curvature information used for a driving convenience system by applying the final curvature to the host vehicle.

9. The method of claim 8, further comprising:
calculating, by a lane detector, a first curvature based on a curved lane captured by the forward sensor;
calculating, by an object recognizer, a second curvature based on a trajectory of one preceding vehicle, the trajectory being captured by the forward sensor; and
estimating, by a curvature calculator, an average curvature of the curved lane using the first curvature and the second curvature.

10. The method of claim 8, further comprising:
calculating, by a lane detector, a first curvature based on a curved lane captured by the forward sensor;
calculating, by an object recognizer, a plurality of second curvatures based on trajectories of a plurality of preceding vehicles, the trajectories being captured by the forward sensor, and calculating, by the object recognizer, relative location information of the preceding vehicles on the basis of a location of the host vehicle; and
calculating, by a curvature calculator, third curvatures, each of which has a straight line from the center point of a circle, the center point being away from the location of the host vehicle by a radius R, to the plurality of preceding vehicles as a radius and calculating, by the curvature calculator, an average value of the to calculated third curvatures of the preceding vehicles to estimate the final curvature.

11. The method of claim 10, further comprising:
calculating the third curvatures, each of which has the straight line from the center point of the circle, the center point being away from the location of the host vehicle by the radius R, to the plurality of preceding vehicles, as the radius using the following equation
$$\frac{1}{R} = \frac{2 y}{{x}^{2} + {y}^{2}}$$
(where R denotes the coordinate value of the center point of the circle, the center point being away from the location of the host vehicle by the radius R, X denotes the X-axis coordinate value of the preceding vehicle, and Y denotes the Y-axis coordinate value of the preceding vehicle).

12. The method of claim 10, further comprising:
calculating the average value of the third curvatures of the preceding vehicles using the following equation
$$\frac{1}{n} {\sum }_{i = 1}^{n} \frac{1}{{R}_{n}}$$
(where n denotes the number of the preceding vehicles).

13. The method of claim 8, further comprising delivering, by a driving controller, curvature information corrected according to the final curvature to a sensor rotating device for rotating the forward sensor or a steering system for changing a steering angle of the host vehicle.

14. A computer-readable storage medium storing a program for executing the method for correcting the curvature information using the surrounding vehicle of claim 8.

15. A computer-readable storage medium storing a program for executing the method for correcting the curvature information using the surrounding vehicle of claim 9.

16. A computer-readable storage medium storing a program for executing the method for correcting the curvature information using the surrounding vehicle of claim 10.

17. A computer-readable storage medium storing a program for executing the method for correcting the curvature information using the surrounding vehicle of claim 11.

18. A computer-readable storage medium storing a program for executing the method for correcting the curvature information using the surrounding vehicle of claim 12.

19. A computer-readable storage medium storing a program for executing the method for correcting the curvature information using the surrounding vehicle of claim 13.
